(19) United States
(12) Patent Application Publication
(10) Pub. No.: US 2011/0247583 A1
(43) Pub. Date: Oct. 13, 2011

(54) Internal Combustion Engine and Components Therefor

(75) Inventors: Nikolay Shkolnik, West Hartford, CT (US); Alexander C. Shkolnik, Cambridge, MA (US); Stephen L. Nabours, Southwick, MA (US); Gnana Prakash Gnanam, Hartford, CT (US); David Collis Kieke, Austin, TX (US); Yehoram Hofman, Newport Coast, CA (US)

(73) Assignee: LIQUIDPISTON, INC., Bloomfield, CT (US)

(21) Appl. No.: 13/085,204

(22) Filed: Apr. 12, 2011

Related U.S. Application Data
(60) Provisional application No. 61/323,174, filed on Apr. 12, 2010.

(51) Int. Cl. F02B 53/00; F02B 55/14; F02B 55/02

(52) U.S. Cl. 123/245; 123/200; 418/140

(57) ABSTRACT

A rotary internal combustion engine includes crank-driven gates to synchronously form chambers for the intake, compression, combustion, expansion and exhaust of a working medium during a high-efficiency hybrid engine cycle. A variety of rotor geometries and sealing apparatuses may work with a rotary engines in the execution of various engine cycles including, but not limited to, a high-efficiency hybrid engine cycle.

### PRIORITY

This patent application claims priority from provisional U.S. patent application No. 61/323,174, filed Apr. 12, 2010, entitled “Internal Combustion Engines and Components Therefor,” naming Nikolay Shkolnik, Alexander C. Shkolnik, Stephen L. Nabours, and Ryan D. Nelms as inventors, the disclosure of which is incorporated herein, in its entirety, by reference.

### TECHNICAL FIELD

The present invention relates to engines, and more particularly to rotary engines.

### BACKGROUND ART

It is known in the art that internal combustion engines may execute a variety of cycles, such as a Diesel cycle, an Otto cycle, or an Atkinson cycle. These cycles all have distinct characteristics, but each has disadvantages that prevent it from achieving higher levels of efficiency while maintaining high power outputs. Increasing the efficiency of engines designed to complete one of these cycles has proven to be challenging. In a conventional engine part of the challenge stems from the fact that all the processes such as compression, combustion and expansion, happen within the same space only at different times. Additional challenges involve creating high compression in the compression chamber and maintaining a constant volume over an interval sufficient to optimize combustion for various operating conditions or loads. Furthermore, with the exception of the Atkinson cycle, which is not completed in a typical combustion engine, efficiency is lost because the expansion cycle is prematurely ended before the products of the combustion process are exhausted and replaced with a fresh intake.

### SUMMARY OF THE EMBODIMENTS

In a first embodiment, there is provided an internal combustion engine for executing an engine cycle. The engine has a housing with an intake port and an exhaust port, and a rotor rotationally mounted to move in a cavity within the housing. The engine also has a gate drive arrangement, including at least one gate crankshaft that drives compression and expansion gates synchronously with the rotor, such that the compression gate and expansion gate periodically engage with the rotor. In addition, a third gate is also configured to engage the rotor. As the rotor turns within the cavity, the engine executes a cycle wherein the rotor, compression gate and expansion gate move synchronously, such that (i) during an intake phase of the engine cycle, the housing, rotor and third gate form an intake chamber, the intake chamber exposed to the intake port; (ii) during a compression phase of the engine cycle, the housing, rotor and compression gate form a compression chamber of finite volume, the rotation of the rotor reducing the volume of the compression chamber from a first volume to a second volume, the second volume being less than the first volume, so as to compress a working medium within the compression chamber; (iii) during a heat addition phase of the engine cycle the volume of the working medium is held substantially constant at the second volume; (iv) during an expansion portion of the cycle, the housing, rotor and expansion gate form an expansion chamber, the rotation of the rotor enlarging the volume of the expansion chamber from the second volume to a third volume, the third volume being greater than the first volume, and (v) during an exhaust portion of the engine cycle, the housing, rotor, the third gate, and the expansion gate form an exhaust chamber, the exhaust chamber exposed to the exhaust port.

In some embodiments, at least one of the compression gate and the expansion gate is slidably mounted with respect to the housing. In some embodiments, at least one of the compression gate and the expansion gate is pivotally mounted with respect to the housing.

Some embodiments include a compression crank connecting arm coupling the compression gate to the compression crank, and some embodiments include an expansion crank connecting arm coupling the expansion gate to the expansion crank.

In some embodiments, the rotor is a right circular cylinder, and in some embodiments the rotor has a center of gravity at its axis of rotation.

In some embodiments, the volume of the working medium is held substantially constant at the second volume as the rotor turns at least five (5) degrees around its axis of rotation during a heat addition phase of the engine cycle.

In some embodiments, at least one of the compression gate and the expansion gate has a circular cross section. In some embodiments, the rotor is eccentrically mounted within the cavity to move rotationally.

A rotor for use in the working cavity of a rotary engine housing includes a cylindrical rotor body having a first face, and a working surface, the working surface having a radially indented notch at a juncture with the first face, the notch establishing a shoulder on the rotor body, the notch including a set of rotor teeth. A floating seal ring is movably disposed in the notch and configured to move axially with respect to the rotor body, and includes sealing teeth complementary to and configured to intermesh with the rotor teeth. As the rotor moves within the working cavity, the floating seal engages the housing, thus providing a sealing surface between the rotor and the housing. In some embodiments, the floating seal ring has a radial surface parallel to the working surface.

In some embodiments, the rotor includes a compliant ring disposed between the floating seal and the notch, the compliant ring configured to urge the floating seal axially away from the rotor body, so as to engage the housing. In some embodiments, the compliant ring comprises a polylmer, while in other embodiments the compliant ring comprises a spring.

In some embodiments, the rotor teeth are disposed on the shoulder and protrude axially, while in some embodiments the rotor teeth are disposed on the shoulder and protrude radially.

An internal combustion engine for executing an engine cycle includes a housing having an intake port and an exhaust port; a working chamber comprising an internal circumferential surface; an eccentric shaft rotatably disposed within the working chamber; and a rotor rotatably coupled to the eccentric shaft, such that a radial surface of the rotor engages the circumferential surface such that rotating the eccentric shaft causes the rotor to roll along the circumferential surface within the housing, and the radial surface of the rotor conforms to a contour of the circumferential surface as the rotor rolls.

In some embodiments, the radial surface of the rotor comprises an outer band, while in some embodiments, the outer band comprises stainless steel, which may have a thickness of between 0.025 inches and 0.075 inches.

In some embodiments, the rotor includes a compliant tube within the outer band. In some embodiments, the compliant tube and the outer band are configured concentrically.

Some embodiments include a bearing within, and configured concentrically with, the outer band.

### BRIEF DESCRIPTION OF THE DRAWINGS

The foregoing features of embodiments will be more readily understood by reference to the following detailed description, taken with reference to the accompanying drawings, in which:

FIG. 1 is a pressure-volume diagram illustrating cycles of various engine cycles;

FIG. 2 is a compression ratio-efficiency diagram for various engine cycles;

FIGS. 3A-3E schematically illustrate an embodiment of a rotary engine;

FIGS. 4A-4H schematically illustrate the rotary engine of FIGS. 3A-3E at various points in its operating cycle;

FIGS. 5A-5C schematically illustrate a rotary engine having round gates;

FIGS. 6A-6F schematically illustrate aspects of embodiments of floating seals;

FIGS. 7A-7H schematically illustrate a rotary engine with a toroidal rotor;

FIGS. 8A-8C schematically illustrate a rotary engine with tubular gates;

FIGS. 9A-9D schematically illustrate a rotary engine with a rolling rotor.

### DETAILED DESCRIPTION OF SPECIFIC EMBODIMENTS

Embodiments disclosed below describe rotary engines, and components of such engines, that are considerably more efficient than customary engines, such as the Wankel engine.

Internal combustion engines currently available for automotive use burn petroleum-based fuels, and yield efficiencies of about 20 to 30 percent. In other words, of the energy available in the fuel, about 20 or 30 percent is used to move the vehicle, while the remaining 70 or 80 percent is wasted, by being lost to heat and friction for example.

In contrast, representative embodiments execute an engine cycle that may be known as the High-Efficiency Hybrid Cycle (HEHC) which includes, among other things, a heat addition portion during which a working medium is held at a substantially constant volume. Such engines may achieve efficiencies of 50 percent or more.

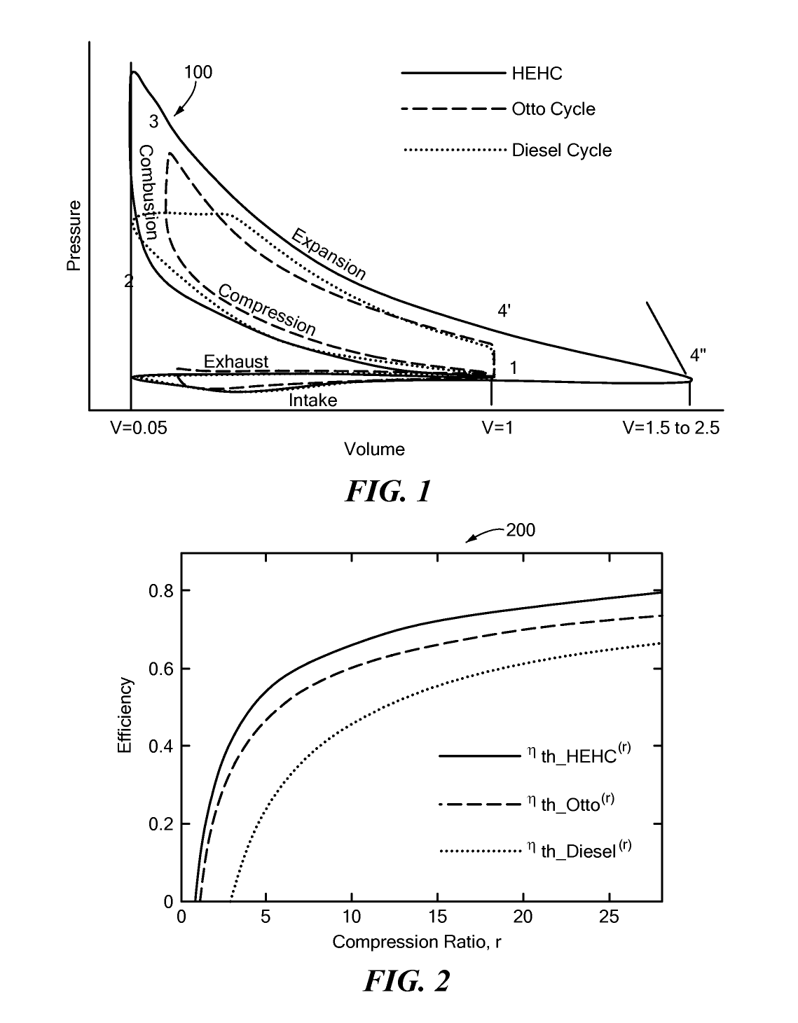

For reference, the basic thermodynamic principles behind the high efficiency hybrid cycle are summarized below, and more fully described in U.S. patent application publication number 2011/0023814 A1, the content and disclosure of which is incorporated herein by reference. The basic premise of the cycle shown in FIG. 1 includes following cycle portions: (1) compression of air to high compression ratio (similar to Diesel cycle engines), (2) heat addition (by combustion of added fuel, or from an external source) at constant volume conditions (similar to Otto cycle engines), and (3) expansion to atmospheric pressure (similar to Atkinson or Miller cycles engines). Because this engine completes a cycle wherein heat is added at a constant volume, during which the pressure increases, the engine may be characterized as an isochoric heat addition engine with over expansion.

An isochoric heat addition engine with over-expansion consists of stationary and movable parts. Stationary parts are sometimes herein referred to as the housing, which housing has an internal cavity. Movable parts may include rotors and gates. The movable and stationary parts generally cooperate to form various chambers in the cavity during various phases of a cycle.

During operation of the engine, a chamber formed between the stationary housing and one or more moving components is filled with a working medium. This working medium undergoes transformations during operation of the engine. In a first phase of the cycle, the chamber is exposed to an intake port, so that air from outside the engine is drawn into the chamber. In a second phase of the cycle, the chamber is isolated from the external environment, and thus has an initial, fixed volume (V1). In this phase, which may be known as “compression stroke,” the chamber is contracted from its initial volume V1 to a smaller volume V2. As such, this phase the portion of the cavity may be called the compression chamber (CmC), having an initial volume V1.

In a third phase, the chamber remains substantially constant at V2 for a finite time period of time, and may be called the combustion chamber (CbC), having a constant volume V2. Subsequently, in a fourth phase the chamber expands to a volume V3, so that V3≧V1≧V2. During this phase, the chamber may be called an expansion chamber (EpC), having a final volume V3. Finally, in a fifth phase, the chamber is exposed to an exhaust port, so that its volume is not finite and working medium is expelled or drawn out from the cavity. During operation of the engine, these phases occur in the indicated sequence to execute a repeating cycle.

In some embodiments, heat could be added to the working medium while the volume “V” of this cavity is at V2≦V≦V1. Work on the working medium is exerted during the phase of operation when the volume is contracted from V1 to V2. No work is exerted or extracted on or from the working medium, except perhaps to overcome small frictional losses, during the phase of operation when the volume of the cavity remains substantially constant at V2. Work is extracted from the working medium as the working medium pushes on the rotor, during the phase of cycle during which the volume if the expansion chamber increases from V2 to V3.

The net work produced by the cycle is the difference between extracted work and work exerted to compress the working medium, also taking into account the losses due to the friction in the system. If heat is added by means of combusting fuel, the engine constitutes an internal combustion engine. If heat is added by external means, such as via heat pipe or directly heating the housing walls, etc., the engine is an external combustion engine.

Due to similarities of this cycle to certain aspects of the Diesel, Otto and Atkinson cycles, this cycle is referred to as a “Hybrid Cycle.” Because the cycle is more efficient than those cycles, the cycle may be known as a high-efficiency hybrid-cycle (“HEHC”).

A pressure-volume diagram 100 for an HEHC engine is shown in FIG. 1. Initially, only the air is compressed in the compression stroke, like in Diesel cycle, since fuel has not yet been provided. Fuel may be added dose to the end of compression stroke or just after the compression stroke. Since the air is already compressed to a relatively high pressure (for example, 55 bar), high injection pressures, similar to those used in modern diesel engines, are required to achieve full combustion and clean exhausts. The operation is akin to a Diesel engines except that combustion occurs at the constant volume, and without a spark as required in Otto cycle engines. However, unlike spark ignition engines, the combustion occurs due to fuel injection into a very hot compressed air. Having said this, however, a spark plug may be used as well. Expansion occurs in this cycle to ambient pressures, similar to Atkinson cycle.

If leakage between moving components and housing is kept at low level, the maximum efficiency of this cycle is expected to be about 57%, while average efficiency is expected to be above 50%.

From a design point of view, implementation of such a cycle will involve the existence of constant volume combustion chamber over a finite time period (or a rotation of the rotor over a non-zero angle) and expansion chamber volume larger than intake volume.

The homogeneous charge hybrid cycle (HCHC) is a modification of the HEHC, in which a lean air/fuel mixture, formed during intake and/or compression strokes, is being compressed as opposed to the compression of only air as in the HEHC cycle. When the mixture reaches temperatures sufficient for auto-ignition at the end of compression stroke, a spontaneous combustion occurs. Compared to HEHC, the HCHC is characterized by slightly lower compression ratio and, therefore, exhibits a lower efficiency.

The HCHC cycle may also be compared with a conventional Homogeneous Charge Compression Ignition (HCCI), which will occur when temperature of air/fuel mixture reaches the auto-ignition point, which, if engine is properly designed, should occur exactly at, or just prior to, the end of compression. The ignition in an HCCI cycle is almost instantaneous throughout the whole volume occurring without flame propagation or shock wave and at lower temperatures (which is a good thing for emissions and engine integrity), albeit, at a lower pressures, which leads to efficiencies lower than those achieved during an HEHC.

A quantitative comparison 200 of ideal cycles, which calculates the maximal theoretical efficiency, is shown in FIG. 2, which data was computed on the basis of below expressions for HEHC, Diesel and Otto Cycles:

$${η}_{th}^{HEHC} = 1 - k \frac{{T}_{4} - {T}_{1}}{{T}_{3} - {T}_{1}} = 1 - k \frac{{r}_{E} - {r}_{C}}{{r}_{E}^{k} - {r}_{C}^{k}}$$

$${η}_{th}^{Diesel} = 1 - ( \frac{1}{k} ) \frac{{T}_{4} - {T}_{1}}{{T}_{3} - {T}_{2}} = 1 - ( \frac{1}{k} ) \frac{{r}_{E}^{- k} - {r}_{C}^{- k}}{{r}_{E}^{- 1} - {r}_{C}^{- 1}}$$

$${η}_{th}^{Otto} = 1 - \frac{{T}_{4} - {T}_{1}}{{T}_{3} - {T}_{2}} = 1 - \frac{1}{{r}_{C}^{k - 1}}$$

In these examples, k=1.3; and rc is the compression ratio; rE is the expansion ratio; and T1 through T4 are temperatures of the working mediums through various points in a cycle. See also points defined in a FIG. 1.

Against the foregoing background, as used in this description and the accompanying claims, the following terms shall have the meanings indicated, unless the context otherwise requires:

A “rotor” is a structure, rotatably mounted in a housing that transmits torque, developed as a result of combustion, to a mechanical output.

A “gate” is a movable structure, for partitioning a volume, that is periodically or continuously in contact with a member, such as a rotor, that is moving with respect thereto. A gate may move with a rotating or translating motion, and such motion need not substantially change the volume of a relevant cavity.

CbC—Combustion Chamber

CmC—Compression Chamber

EpC—Expansion Chamber

EhC—Exhaust Chamber

CV CbC—Constant Volume Combustion Chamber

HEHC: High Efficiency Hybrid Cycle

HCHC: Homogenous Charge Hybrid Cycle

FI: Fuel Injector

WM: Working Medium

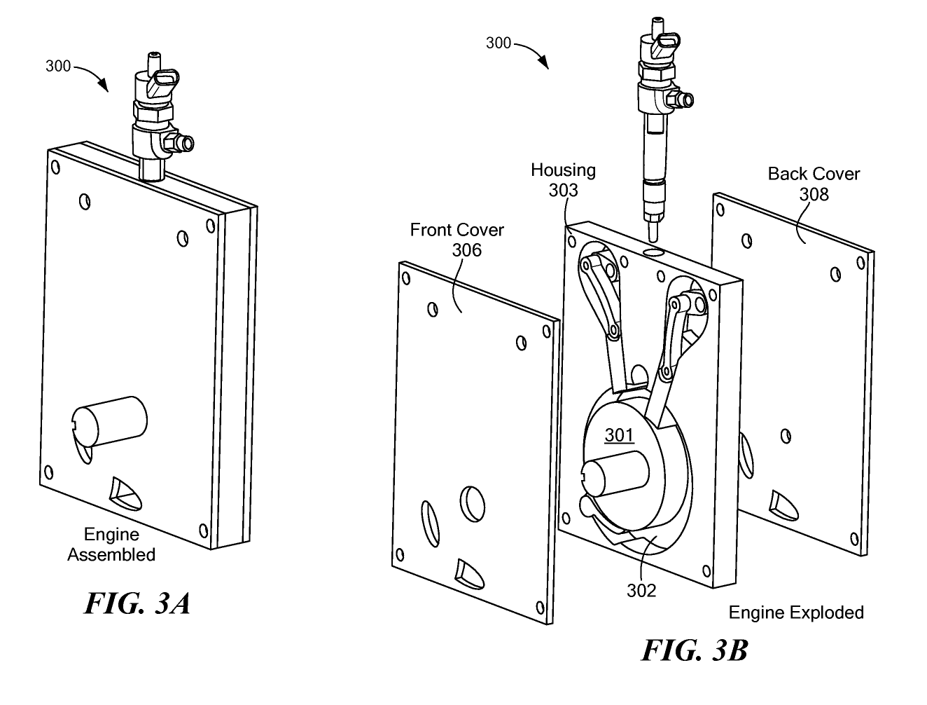

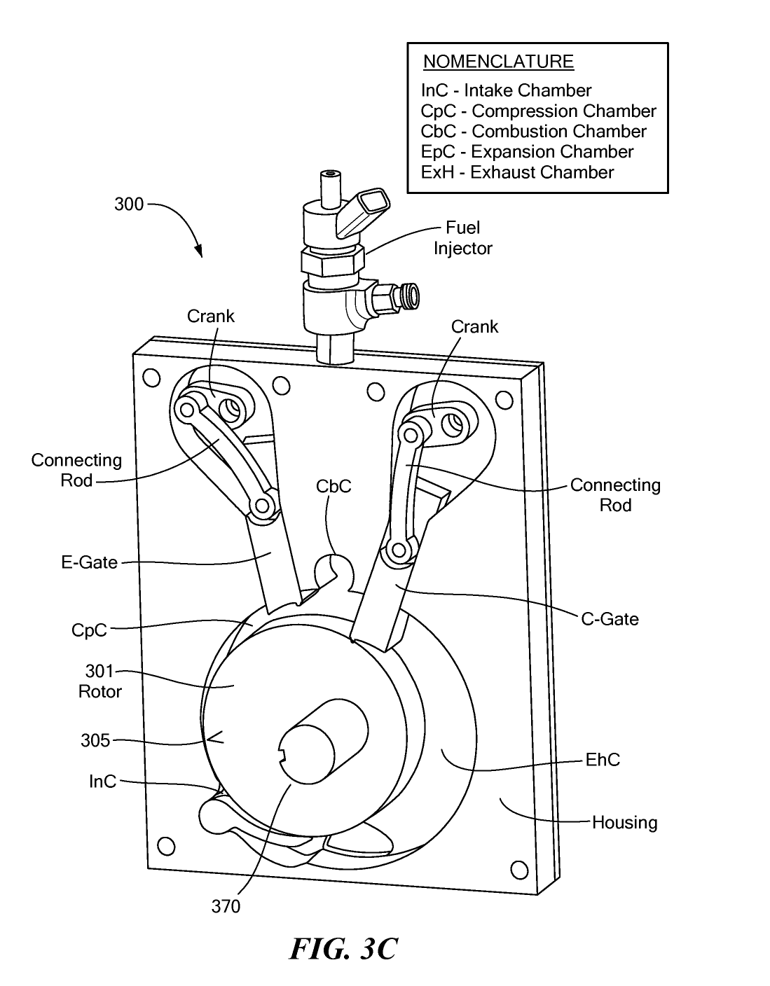

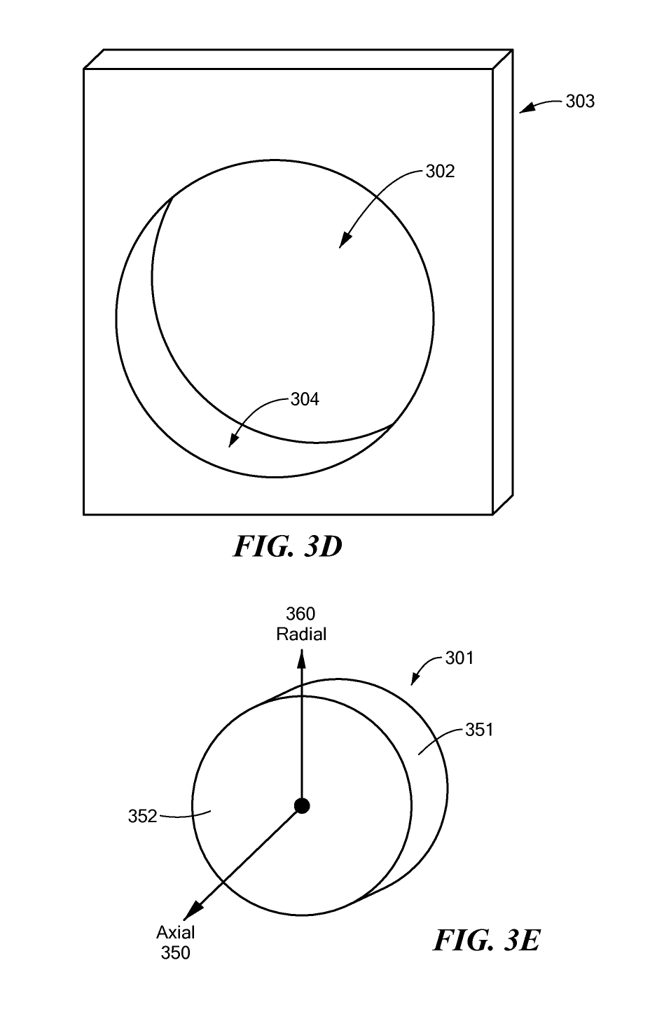

Various embodiments include a number of elements that cooperate as the engine executes a cycle. One embodiment 300 includes a circular rotor 301 eccentrically mounted to rotate in a circular cavity 302 within housing 303, as schematically illustrated in FIG. 3B. Generally, embodiments describe single-rotor rotary engines, wherein a single rotor performs all of the compression of the working medium. In other words, embodiments described below are capable of achieving compression ratios of 18 or greater without the need for a companion compressor, in contrast to some prior art engines in which a companion compressor pre-compresses air before the air enter the working cavity of the rotary engine. Nevertheless, embodiments described herein could be configured to include such a companion compressor, although doing so increases the weight and complexity of the engine.

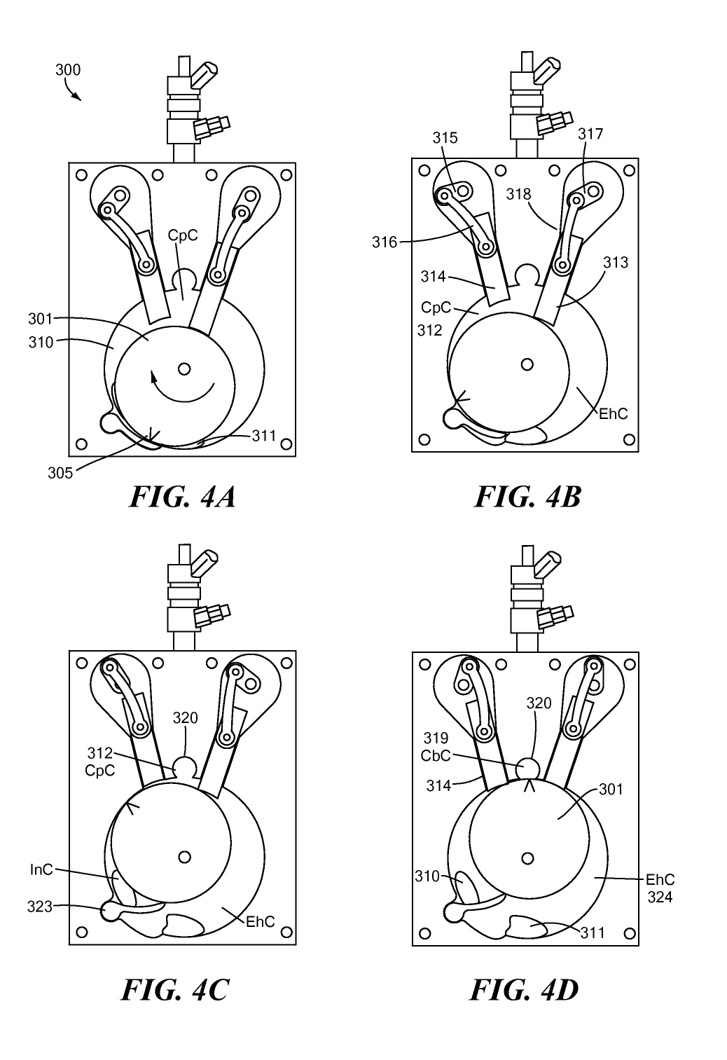

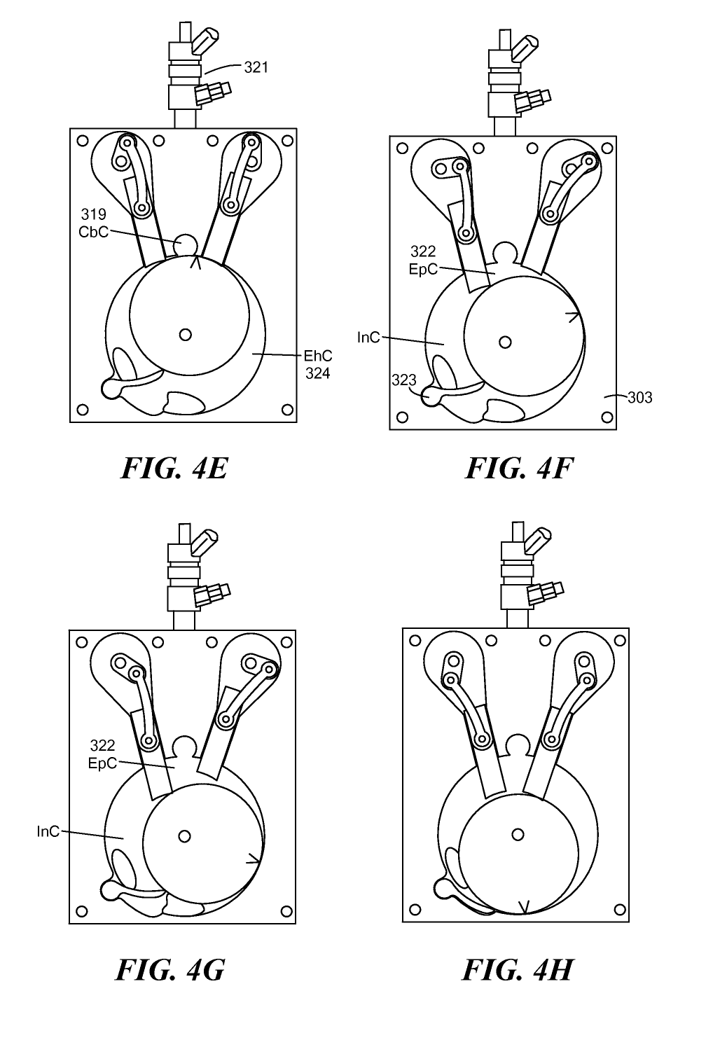

For ease of reference in describing this and other embodiments in this application, certain terms may be defined using FIG. 3B, and FIGS. 3D and 3E to illustrate. Specifically, an “axial” direction with respect to the right circular cylinder 301 of FIG. 3E is a direction 350 parallel to the cylinder's axis, and a “radial” direction is a direction 360 normal to that axis, as illustrated in FIG. 3E. The cylinder 301 has a radial surface 351 (which may be known as a working surface of a rotor) and a face 352, as well as another face (not shown) on its obverse side. Similarly, a cavity 302 in a housing 303 may have a cylindrical shape, in which the cylinder has an axis. As such, a “radial surface” 304 (which may be known as a “circumferential surface”) is a surface of the cavity radially disposed with respect to that axis. The foregoing definitions are general in nature, and can also be used to describe rotors and cavities that have non-circular cross-sections. In the embodiment of FIG. 3B, rotor 301 is a right cylinder configured to move eccentrically within the cavity, such that at least one point on the surface of an axial cross-section of the cylinder is in contact, or very nearly in contact, with the housing in some orientations. That point, which may be known as the apex point 305, separates chambers from one another, and is schematically illustrated by a small arrowhead on the rotor 301 in FIG. 3C and FIGS. 4A-4H.

One complete revolution of the rotor 301, and therefore one complete execution of the engine's cycle, is schematically illustrated by FIG. 4A-4H.

In FIG. 4A, the rotor 301 is schematically illustrated with its apex point 305 between an intake port 310 and an exhaust port 311. In this position, a portion of the cavity 302 is exposed to the intake port 310, and air enters through the intake port 310 and will become working medium. At the same time, another portion of the cavity 302 is exposed to the exhaust port 311, through which working medium from a preceding cycle is exhausted.

In FIG. 4B, the rotor 301 has rotated a few degrees in a clockwise direction, and eclipsed the intake port 310, such that a working medium is contained within a compression chamber 312 of finite volume (V1). As shown in the Figure, the compression chamber 312 is formed by the walls of the cavity 302, the rotor 301, and a compression gate 313, which is engaged with the rotor 301. In this embodiment, the compression gate 313 is “flat” in that each face of the gate is a rectangle. However, other gate shapes may be used, as discussed further below. The compression gate 313 is also slidably mounted within the housing 303, but could also be pivotally mounted, for example.

The volume of the compression chamber is finite because the engine also includes a front cover 306 and a back cover 307, which together enclose the cavity 302, as schematically illustrated in FIGS. 3A and 3B, except for the locations of the intake port or ports 310, and the exhaust port or ports 311, as discussed further below. For ease of illustration, however, some figures omit the front 306 and back 307 covers.

As the rotor 301 rotates in a clockwise direction, it reduces the volume of the compression chamber 312 as shown in FIG. 4B-FIG. 4C, and thereby compresses the working medium. During this phase of the cycle, an expansion gate 314 remains withdrawn from the rotor 301 (FIG. 4B) such that the working medium and the rotor 301 (e.g., apex point 305) may pass by the expansion gate 314. In other words, during the compression phase of the engine cycle, the expansion gate 314 stays out of the way.

The motion of expansion gate 314 is controlled by expansion crank 315, to which expansion gate 314 is coupled. In some embodiments, the expansion crank 315 is coupled to the expansion gate 314 by an expansion connecting rod 316_.

The compression crank 317 turns synchronously with the rotor 301 such that the compression gate 313 also moves synchronously with the rotor 301. In some embodiments, the compression crank 317 is coupled to the compression gate 313 by a compression connecting rod 318. Indeed, the motion of the compression gate 313 is reciprocal, and sinusoidal with the rotation of the rotor 301. In some rotary engines, the motion of gates 313 and 314 are controlled by cams and springs. However, crank-driven gates such as expansion gate 314 and compression gate 313, provide certain advantages. For example, crank-driven gates may operate more quietly (less noisily) than cam-driven gates, and more reliably at higher revolutions per minute (RPM) than cam-driven gates. Also, cranks allow gates to be more massive than cam-driven gates, thus allowing the gates to be stronger. In addition, the gate travel provided by the cranks yields a higher power density than similar gates with relatively less travel. Finally, use of cranks enables the engine to be scaled to dimensions larger than cams would effectively allow.

Turning to FIG. 4D and FIG. 4E, the expansion gate 314 has moved to engage with the outer surface of the rotor 301, so that a combustion chamber 319 is formed by the rotor 301, the surface of the chamber 302, the compression gate 313 and the expansion gate 314. At this point in the cycle, the working medium is reduced to a combustion volume (V2). In the embodiment of FIG. 4D, the combustion chamber 319 includes the volume of a recess 320, which is part of the cavity 302.

The volume (V2) of the combustion chamber 319 is smaller than the initial volume (V1) of the compression chamber 312. In some embodiments, the compression ratio (the ratio V1/V2) may be higher than conventional rotary engines. For example, a convention Wankel rotary engine may have a compression ratio of approximately 9.5:1, while embodiments of engine 300 may have greater ratios.

Some embodiments may have a compression ratio of 11:1 or 12:1, or even more. In fact, some embodiments may have a compression ratio in the range of between 18:1 to 25:1 or greater. Indeed, greater compression ratios are theoretically possible, but in practice suffer from difficulties in maintaining the integrity of the chambers as against the high pressures. In addition, although higher compression ratios may theoretically provide higher engine efficiencies, increasing the compression ratios would likely yield diminishing returns as the size and weight of the engine would have to increase to, for example, handle the increased pressures.

The volume of the combustion chamber 319 remains substantially constant at volume V2 for a non-zero portion of the rotation of the rotor 301. Such a portion may be expressed in terms of the geometry of the rotor, or in terms of time. For example, the volume of the combustion chamber 319 remains substantially constant as the rotor 301 turns through a predetermined number of degrees or radians of its rotation. For example, in the engine of FIG. 4D-4E, the combustion chamber 319 remains at a substantially constant volume (V2) as the rotor 301 turns through an angle of at least five (5) degrees, and may remain substantially constant as the rotor 301 turns through an angle of up to thirty (30) degrees.

If the angular velocity of the rotor is known, the time during which the combustion chamber 319 remains at a constant volume (V2 in this embodiment) can be expressed in terms of time. However, given that the angular velocity of the rotor 301 will vary as a function of the operating condition of the engine 300, it may be more practical to use a geometric description.

As a practical matter, factors such as machining tolerances may result in a combustion chamber volume that changes slightly as the rotor 301 turns, although that volume remains within limits that allow the engine to function according to the HEHC cycle. Such a volume is, for purposes of this application, still considered to be a constant volume. For example, in some embodiments, the combustion chamber 319 may maintain a volume within +/−0.5 percent (one-half of one percent) of its initial volume over at least 5 degrees of the engine cycle, and some embodiments maintain such a volume over approximately 10 degrees of the engine cycle. Stated alternately, the volume may change +/−0.5 percent during the existence of the combustion chamber 319 and still be considered to have a “constant” volume.

A fuel pump or fuel injector 321 introduces fuel into the combustion chamber 319. In this embodiment, the temperature and pressure of the working medium is such that the fuel ignites without the application of a spark or other ignition energy (i.e., auto ignition), and burns rapidly to complete its combustion as the combustion chamber 319 retains its substantially constant volume (V2). As such, heat is added to the working medium within the combustion chamber 319.

Subsequently, the rotation of compression crank 317 begins to pull the compression gate 313 away from the rotor 301, as schematically illustrated in FIG. 4F. As such, an expansion chamber 322 is formed by the cavity 302, the rotor 304 and the expansion gate 314, along with the front plate 306 and the back plate 307, The expansion chamber 322 is of a finite, but variable volume. As such, the pressure of the working medium forces the rotor 301 to continue its clockwise rotation, thus increasing the volume of the expansion 322, as schematically illustrated in FIGS. 4F-4H. In other words, the expansion of the working medium yields work output.

Eventually, the rotor 301 completes its cycle and is again in the position schematically illustrated in FIG. 4A. In this location, the working medium in the expansion chamber (which may be known as the exhaust chamber 324) is exhausted through the exhaustion port 311. A the third gate 323 is pivotally coupled to the housing, but could also be slidably mounted, similar to the compression gate 313 and expansion gate 314, or could be a leaf spring, for example. For some orientations of the rotor 301, the third gate 323 serves as a barrier between the intake port 310 and the exhaust port 311. In FIG. 4A, the third gate 323 is receded into the housing 303.

Although the discussion of FIGS. 4A-4H describe a complete cycle, it should be noted that various portions of the engine 300 execute various portions of such a cycle simultaneously. For example, as working medium is being compressed from V1 to V2 as illustrated in FIGS. 4B and 4C, a previous cycle is expelling its working medium. Similarly, as an expansion chamber is expanding in FIGS. 4F-4H, fresh working medium is being drawn in through the intake port 310.

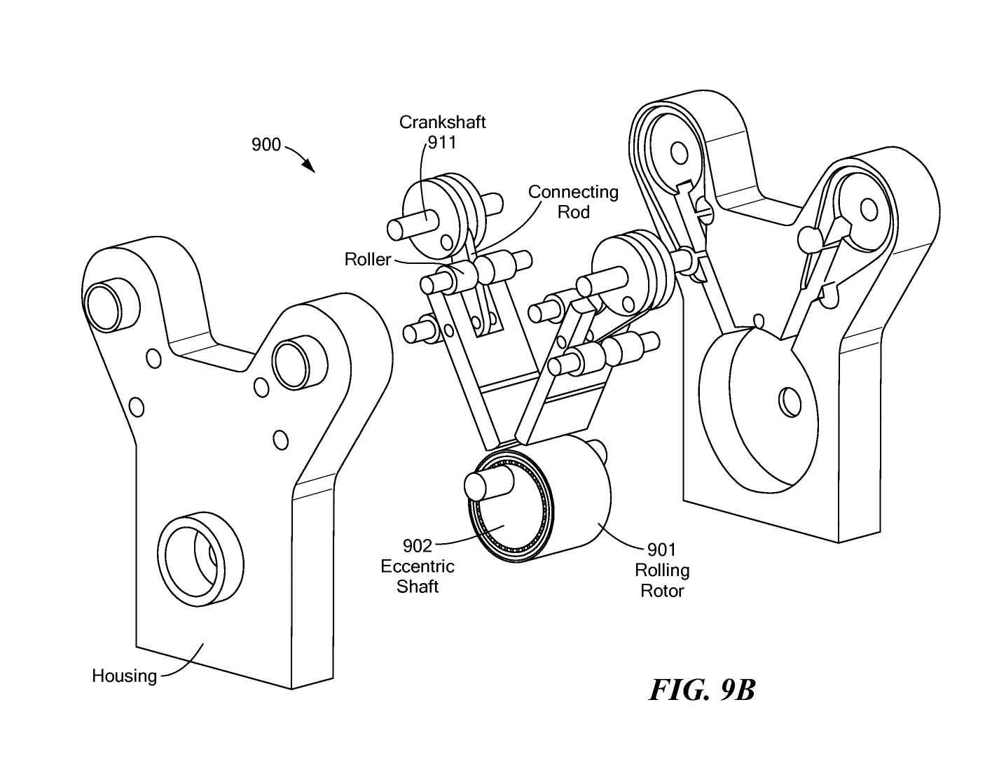

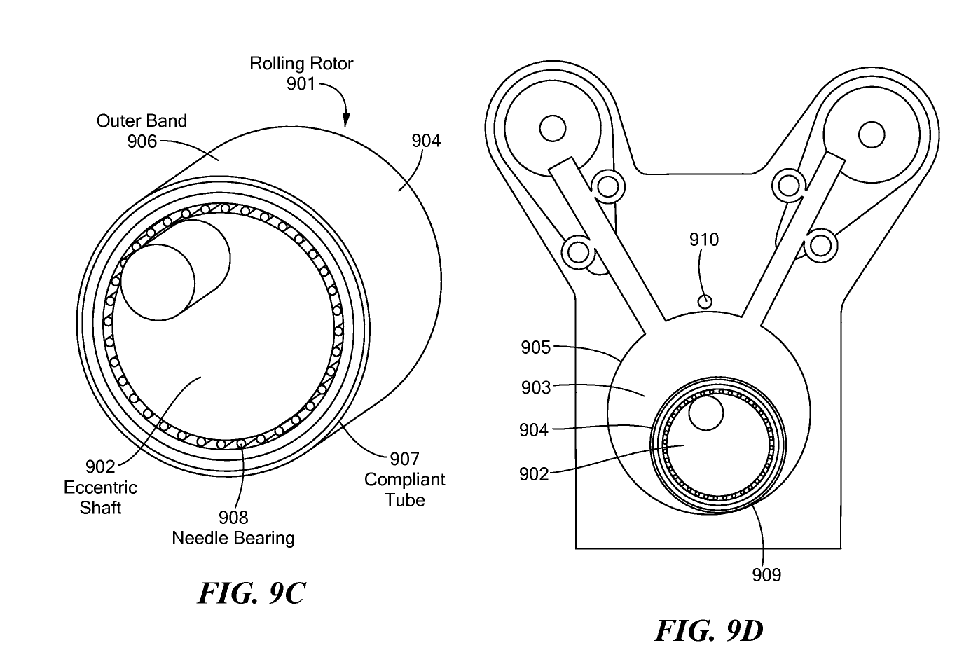

FIGS. 3B, 3C and 4A-4H schematically illustrate a gate drive arrangement that has two separate cranks, compression crank 317 and expansion crank 315. The expansion crank 315 is driven by an expansion crank shaft (not shown; see crankshaft 911 in FIG. 9B for example), and the compression crank 317 is driven by a compression crank shaft (not shown), both of which are coupled to rotor shaft 370, such that the rotor shaft 30 and expansion crank shaft and compression crank shaft turn synchronously. However, in some embodiments, a gate drive arrangement includes a single crank shaft (which may be known simply as the “gate crankshaft”) coupled to the expansion crank 315, the compression crank 317 and the rotor shaft 360, such that such that the single gate crankshaft, the expansion crank 315 and the compression crank 317 turn synchronously with the rotor 301.

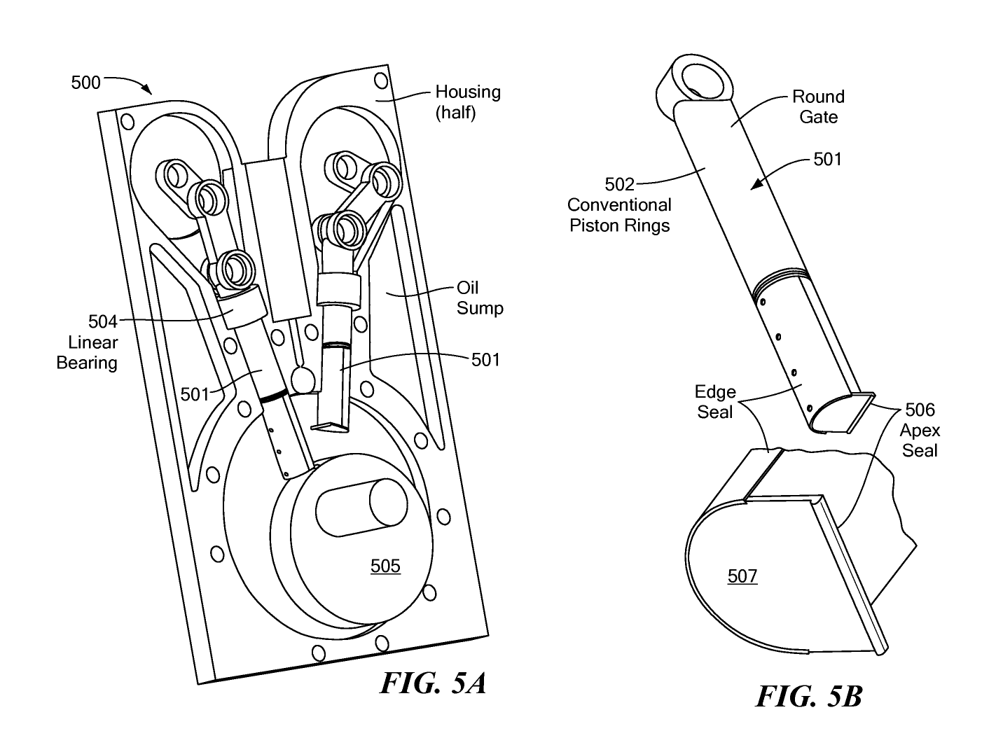

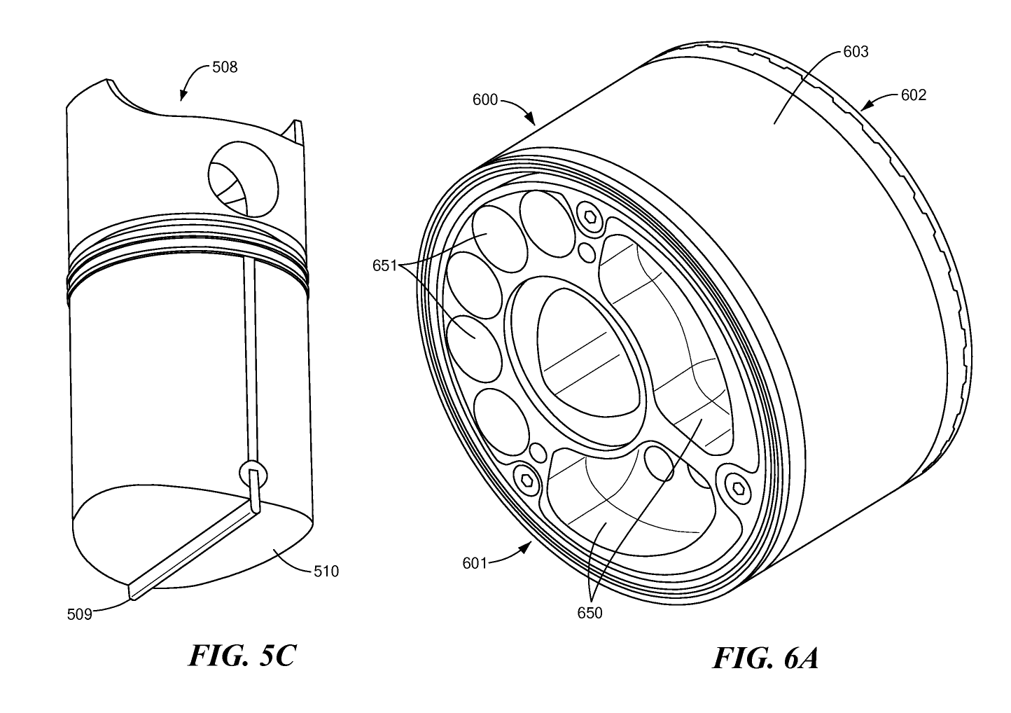

An embodiment 500 schematically illustrated in FIGS. 5A-5C includes round gates 501. In other words, the gates 501 in FIGS. 5A-5C have a circular cross-section. The utility of round gates is not limited to the rotary engine described above, and such gates may be used in a variety of rotary engines executing a variety of engine cycles. For example, a round gate may be driven by a cam, instead of the cranks as illustrated in FIGS. 5A and 5B.

Round gates provide an advantage in that they may be sealed with seal rings 502 similar to those that seal pistons in conventional piston engines (i.e., piston rings), as illustrated in FIG. 5B. The engine 500 may also include linear bearings 504 around the circular gates.

To seal against the rotor 505, each gate 501 includes an apex seal 506. In the embodiments of FIGS. 5A and 5B, the apex seal 506 is offset from the center of perimeter of the gate by a footing 507. However, in other embodiments 508 the apex seal 509 crosses the face 510 of the circular gate 508, and may bisect the face 510 of the circular gate 508, as schematically illustrated in FIG. 5C.

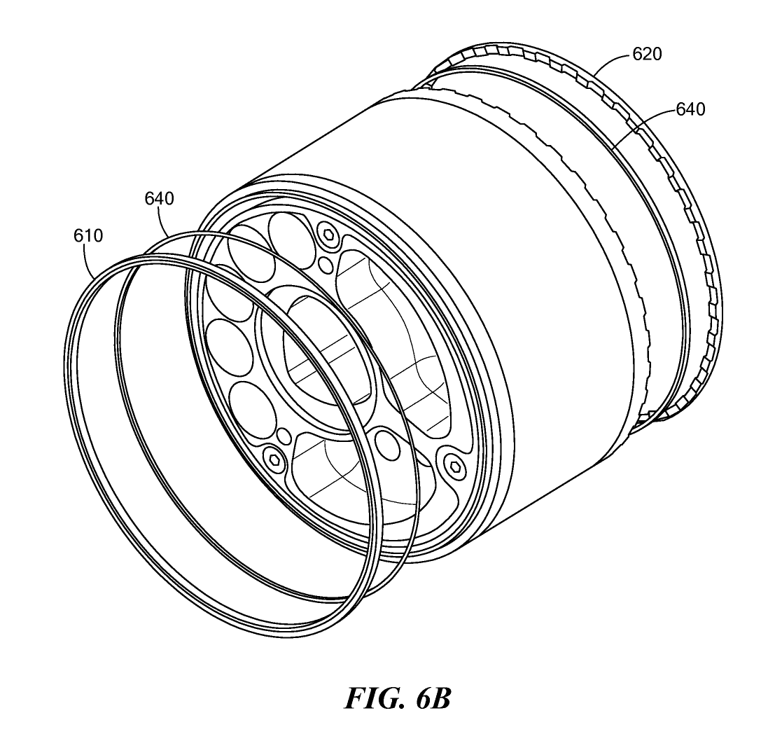

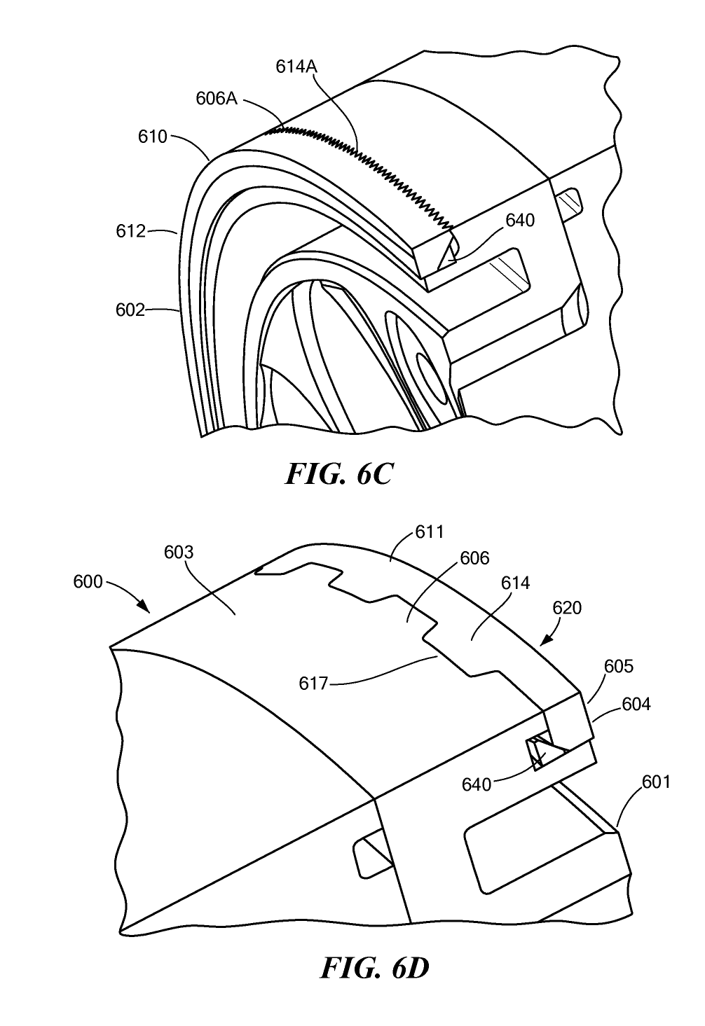

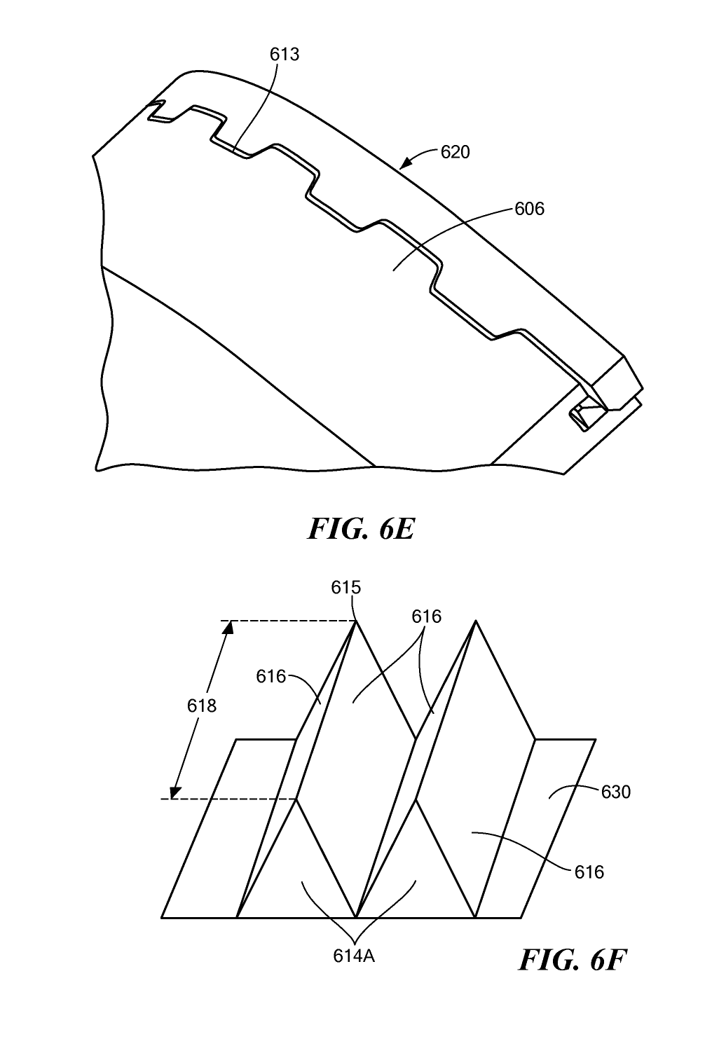

The rotor 301 in FIGS. 4A-4H is illustrated as a solid right cylinder, but other rotor configurations may be used. For example, a rotor need not be solid. A rotor 600 with cavities or voids 650, and heavy metal (e.g., tungsten) inserts 651 is schematically illustrated in FIG. 6. Such voids or cavities and heavy inserts may move the center of gravity of the rotor 600 such that the center of gravity is displaced from the geometric center of the rotor. In some embodiments, the center of gravity may be moved nearer to, or even to be coincident with, the axis about which the rotor turns. Such an embodiment may balance the weight of the rotor 600 so as to reduce or eliminate wobble that may arise from the rotation of an unbalanced rotor. In some embodiments, the rotor can have a cam-like shape, such that a gap between the working surface of the rotor and the gate (or an apex seal on a gate) varies as a function of the rotation of the rotor in ways different than produced by the circular cross-section of a right cylindrical rotor.

The rotor 600 in FIGS. 6A and 6B also schematically illustrates two embodiments 610 and 620 of a floating seal. One challenge in the art of rotary engines is providing seals between the various chambers sufficient to withstand the pressure differentials between them. For example, the pressure within a combustion chamber, after heat has been added (e.g., after fuel combustion) is considerably higher than the pressure in adjacent chambers. As such, the working medium in the combustion chamber, or even in an expansion chamber, tends to leak out to a lower-pressure environment in the absence of adequate seals. Leakage paths may include, for example, leakage across the cylindrical face of a rotor from one chamber to another, or leakage from a chamber towards the face of the rotor (e.g., between the face of the rotor and the housing, for example). The development of a system of seals, known as the Wankel grid and described in U.S. Pat. No. 3,064,880, enabled the commercially successful Wankel rotary engine. The Wankel grid does not prevent all leaking, but does impede the flow of working medium along the various leakage paths to a degree that allows the engine to operate.

The floating seals 610, 620 schematically illustrated in FIGS. 6A and 6B seek to address another leakage path. Specifically, working medium may tend to leak from one chamber to another by traveling along the face 601 of the rotor 600 at or near its circumferential periphery. For example, the working medium may leak from a chamber to a space adjacent to the face 601 of the rotor 600, and then follow a path along the periphery of the rotor face 601.

One embodiment of a floating seal 620 includes a seal ring co-located with the rotor 600 is illustrated in FIG. 6D and FIG. 6E. The right circular rotor 600 has a first face 601 and a second face 602 on a side obverse to the first face 601. The first face 601 and second face 602 represent the ends of a right circular cylinder. The rotor 600 also has a surface 603 representing the radial surface of a right circular cylinder. The surface 603 of the rotor 600 may be known as a “working surface” because it engages the working medium within a rotary engine.

The floating seal 620 has the same shape as an axial cross-section of a rotor 600 (e.g., if the rotor is a right cylinder, then the seal ring is circular; if the rotor has an elliptical cross section, then so does the seal ring, etc.). Illustrative embodiments disclose a right cylindrical rotor, but the disclosed seal ring may be adapted to rotors of a variety of geometries, and are not limited to rotors with circular cross-sections.

Floating seal 620 and rotor 600 are configured so that the radial surface 611 of the seal ring 620 is adjacent to the radial surface 603 (working surface) of the rotor 600. Effectively, the radial surface 611 of the seal ring 620 and the radial surface 603 of the rotor 600 form a continuous radial surface. Indeed, a surface of the floating seal 611 may be considered a part of the working surface 603 of the rotor 600. In some embodiments, the seal ring 620 may be described as a companion rotor, sharing a cross-section and axis of rotation with a rotor.

Unlike prior art face seals, the floating seals 610 and 620 form a seal along the perimeter of the rotor 600. Accordingly, and unlike some prior art sealing mechanisms, an engine with a floating seal may avoid the need for additional seals at the periphery of the rotor, such a buttons seals that are known in the art.

A notch 604 at the juncture of the radial surface 603 of the rotor 600 and the face 601 of the rotor supports the floating seal 620, but also allows the floating seal 620 to move axially with respect to the rotor 600. In some embodiments, the notch 604, radial surface 603 and face 601 of the rotor 600 may form a shoulder 605. In some embodiments, the shoulder 605 may be “L” shaped in cross-section, although other cross-sections may be used, including beveled cross-sections.

In operation, and because the floating seal 620 may move axially with respect to the rotor 600, a circular face 612 of the floating seal 620 will engage the housing, such as a front plate 306 or back plate 307 in FIG. 3B for example. The interface between the floating seal 620 and the housing forms an effective seal against the escape of working media from a chamber to the face 601 of the rotor 600. However, axial displacement of a floating seal 620 may create a gap 613 between the floating seal 620 and the rotor 600.

To impede the flow of working medium through the gap 613, the floating seal 620 includes teeth 614 (which may be known as seal teeth) that engage corresponding teeth 606 on the rotor (which may be known as rotor teeth), as schematically illustrated in FIG. 6D, for example. A finer set of seal teeth 614A and rotor teeth 606A are schematically illustrated in FIG. 6C. Such teeth 614A may be described as “serrated” teeth. Embodiments of two such teeth 614A on a surface 630 are schematically illustrated in FIG. 6F, in which each tooth 614A has a peak 615 at the interface of two faces 616. In some embodiments, such as the floating seal 620 in FIG. 6D for example, the peak may have a flatter top than the peaks 615 of FIG. 6F. Such a flattened top may be known as a “land” 617. For ease of reference, this application may refer to such features as a peak or peaks. Each peak 615 defines a tooth axis along its length, as indicated by the double-headed arrow 618 in FIG. 6F.

The teeth 614 in FIG. 6C may be described as having a radial orientation because the peak 615 of each tooth (e.g., the tooth axis) lies along a line that extends radially from geometric center of the cylindrical rotor 600. In other embodiments, the rotor and floating seal may have teeth oriented such that the peak of each tooth is parallel to such an axis. Such teeth may be described as having an axial orientation. The intermeshing teeth (e.g., teeth 614 and 606) serve to seal the periphery of the rotor 600 by creating a torturous path, thereby impeding the flow of working medium.

Embodiments in FIGS. 6A-6E also include a compliant ring 640 disposed between the floating seal 610, 620 and the rotor 600 (i.e., within the notch 604). The compliant ring 640 biases or urges the floating seal 610, 620 axially away from the rotor 600 to facilitate the floating seal engaging with an opposing face of, for example, a front cover. A compliant ring may be made of high temperature polymer such as Polyetherketone (PEK) or polyetheretherketone (PEEK) which may operate reliably up to 288 degrees Celsius, or other compliant material. In some embodiments, the compliant ring may be a spring or spring mechanism such as coil spring or a wave spring. For example, wave springs are available from the Smalley Steel Ring Company of Lake Zurich, Ill., 60047, USA. Friction resulting from the interface of the floating seal and a cover as the rotor turns will cause a slight counter-rotation of the floating seal so as to force the intermeshing teeth into contact with each other.

Although the rotor 301 of FIGS. 4A-4H is a right cylindrical rotor, other rotor geometries may be viable for some engine implementations. For example, a rotor may have an oval or elliptical cross-section. Other rotor embodiments may have cross-sections with compound shapes (i.e., shapes have varying curvatures at various points, or even flat portions).

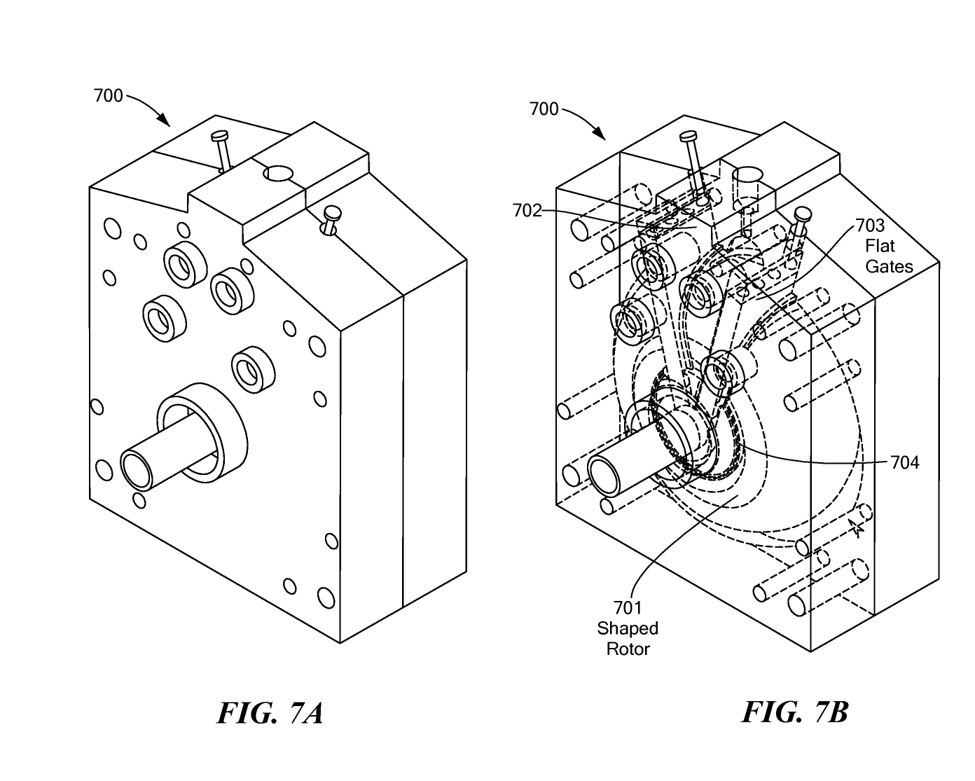

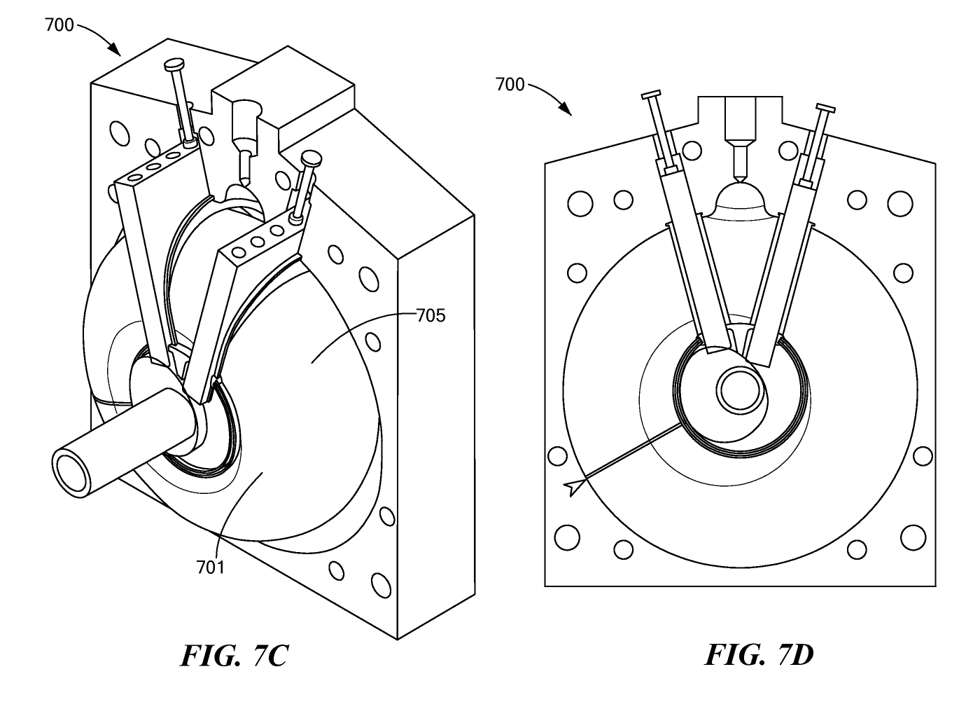

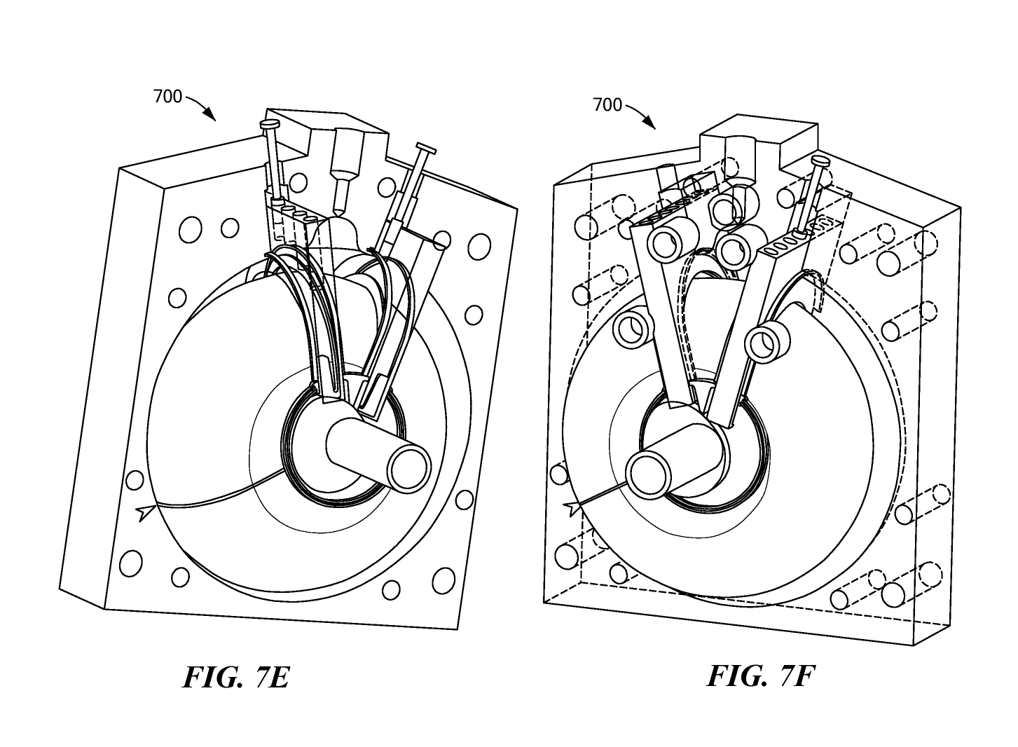

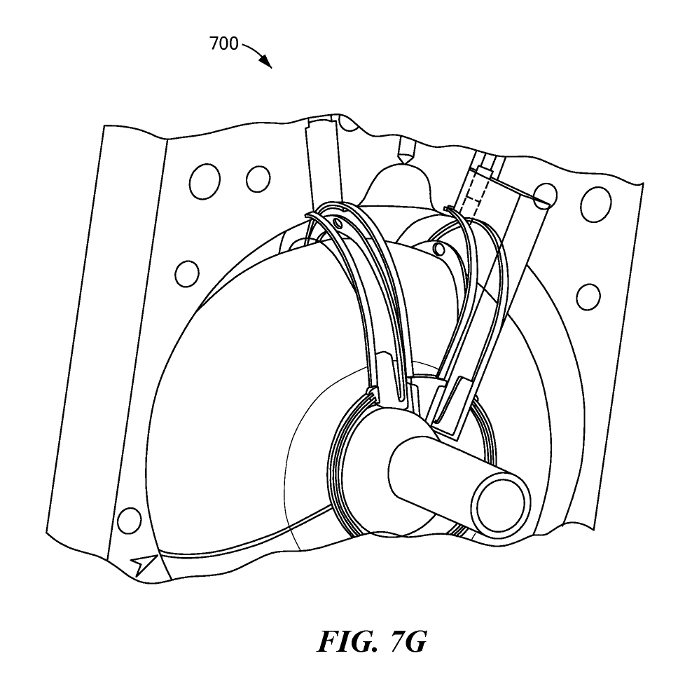

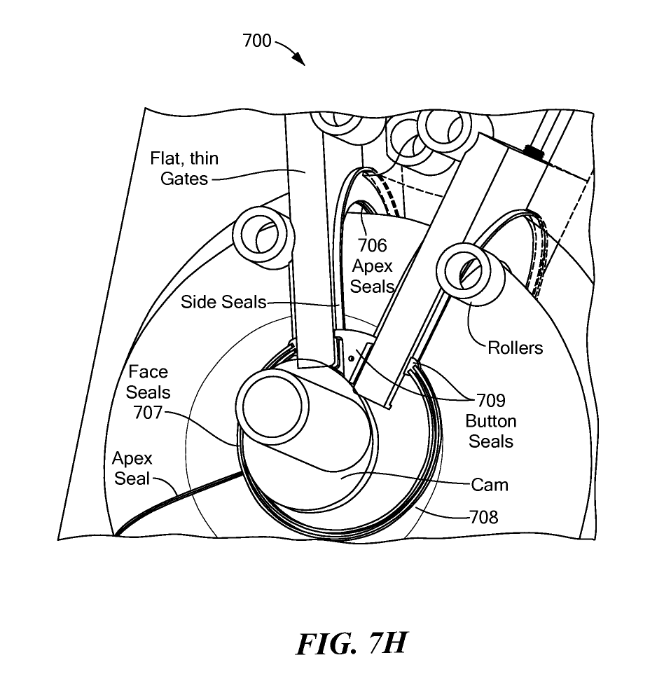

One alternate embodiment of a rotor 701 is schematically illustrated in FIG. 7B, and has a toroidal (or donut) shape. Rotor 701 is shown as part of engine 700 in which gates 702 and 703 are driven by the cams 704 disposed in the central cavity of the rotor 701. One advantage of a toroidal rotor 701 is that is presents a continuous curved surface 705 (again, a “working surface”) to the gates 702 and 703. The gates 702 and 703, in turn, have a concave cross-section that is complementary to the working surface 705. This configuration facilitates sealing the interface between the gates 702 and 703 and the working surface 705.

Specifically, in prior art engines seals between gates and rotors, and/or between rotors and housing, are linear and parallel to the rotor's central axis (e.g., in the case of a right cylindrical rotor) or to its axis of rotation. In contrast, the apex seals 706 in the gates 702 and 703 in FIG. 7B-7H, for example, are curved to complement the shape of the rotor 701. As schematically illustrated in FIG. 7H, for example, portions of the gate apex seal 706 are parallel to an axis running through the geometric center of the rotor 701. In other words, a line tangent to the curved apex seal 706 is, at some point on the apex seal, parallel to such an axis. In the same embodiment, however, other portions of the gate apex seal (which may be known as “side seals”) are perpendicular to such a tangent line, or otherwise have a large angle with respect to such a tangent line, such as 80 degrees or more.

This configuration allows a long, continuous seal (e.g., longer than prior art apex seals), and also allows the interface between apex seals 706 and face seal 707 to be closer to the geometric center of the rotor 701. Accordingly, the face seal 707 has a smaller diameter, and thus less area (perimeter) for potential leakage. Further, some embodiments include two or more concentric face seals 707 and 708, as schematically illustrated in FIG. 7H, which also includes a button seal 709 at the interface of the gate seal 706 (or side seal) and the face seal 707.

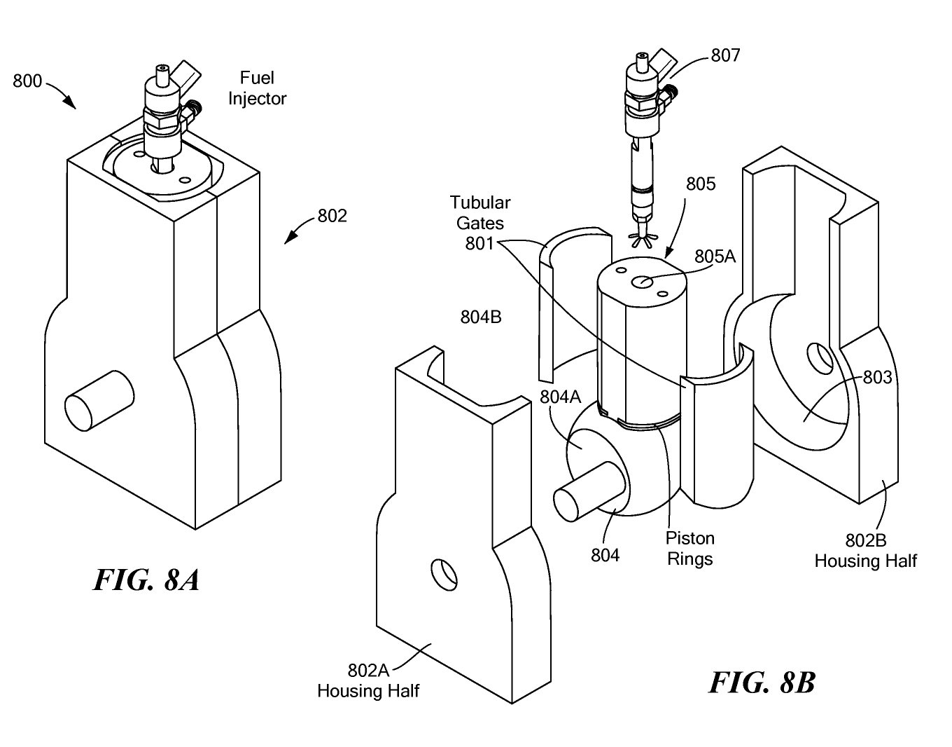

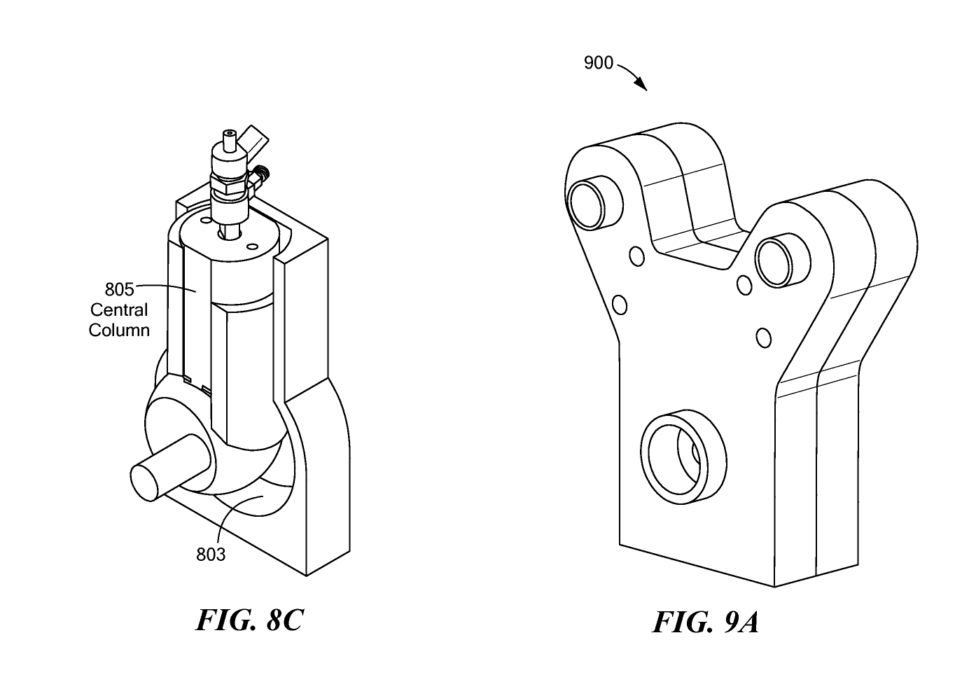

The gates 702, 703 in FIGS. 7B-7H are flat and thin, but other gate geometries may be viable. For example, curved gates 801 are schematically illustrated in another embodiment 800 of a rotary engine in FIGS. 8A-8C. In the view of the engine 800 of FIG. 8B, the engine housing 802 includes two housing halves 802A-802B that together contain the moving elements of the engine and form a cavity 803. In this embodiment, the rotor 804 is round, and may be a portion of a sphere. Specifically, the rotor may be a sphere with two opposing flat faces—face 804A and opposing face on the obverse side (not visible) of the rotor 804.

The gates 801 have a curvature, and may be described as tubular, although neither gate forms a complete tube. The gates 801 form a partial sleeve around a rounded central column 805; the central column 805 having a geometry in cross-section that is complementary to the curvature of the gates 801.

The gates 801 engage the outer surface 804B of the rotor 804 to form the various chambers corresponding to the chambers described in previous embodiments, and piston rings 806 form seals between the central column 805 and the gates 801. A fuel injector 807 provides fuel to a combustion chamber at the interface of the central column 805 and the rotor 804 via a cylindrical aperture 805A through the central column 805.

Another embodiment of a rotor 901 in a rotary engine 900 is schematically illustrated in FIGS. 9B-9D, that may be known as a “rolling rotor.” The rolling rotor 901 in this embodiment is coupled to an eccentric shaft 902, and rotates eccentrically through an engine cycle in a rotary engine 900. Unlike other rotors, however, the rolling rotor 901 is not fixedly coupled to the eccentric shaft 902. Rather, a rolling rotor 901 is rotatably coupled to the eccentric shaft 902. In other words, the rolling rotor 901 is configured to rotate about the eccentric shaft 902 as it progresses through an engine cycle. In some embodiments, no point on a rolling rotor 901 bears a fixed spatial relationship to any point on the eccentric shaft 902. As the eccentric shaft 902 completes a complete revolution, the rolling rotor 901 will complete more than one complete revolution around the eccentric shaft 902.

In the embodiment of FIG. 9D, the diameter of the rolling rotor 901 is such that at least one point on the periphery of the rotor 901, when mounted to the eccentric shaft 902, would extend beyond the boundary of the cavity 903. Therefore, disposing the rolling rotor 901 within the cavity 903 requires that either the periphery of the cavity 903, or the surface of the rotor 901, be deformed or displaced.

In some embodiments, the outer surface 904 of the rotor 901 deforms similar to the way a pneumatic tire deforms where it contacts a road surface. In the case of a deforming tire, a portion of the tire becomes flat, conforming to the shape of the road surface. With a rolling rotor 901, however, the rotor 901 conforms to the shape of the radial surface 905 of the cavity 903 (which surface may also be known as a “circumferential” surface). In other words, an arc of the rotor's periphery has a radius greater then its radius in a non-deformed state. In FIG. 9D, a portion of the peripheral surface 904 of the rolling rotor 901 is deformed in such a way that the radius of that portion is greater than the radius of an un-deformed (circular) rolling rotor 901. The deformed portion may constitute at least two degrees of the circumference of the rotor 901, but may exceed two degrees in some embodiments.

In other embodiments, the outer layer 904 of the rolling rotor 901 is rigid, and does not deform to conform to the shape of the radial surface. Instead, the outer band 906 of the rotor 901 displaces in a direction normal to its contact with the radial surface 905 of the cavity 903. In other words, the geometric center of the outer band's axial cross section is displaced.

Such displacement is facilitated by the compression of a compliant member 907 disposed within the outer band 906, as described below. In an unloaded condition, the outer band 906 and compliant member 907 may be concentric. However, when the rotor is placed in the cavity 903 of a rotary engine housing 900, contact between the rotor 901 and the radial surface 905 of the cavity 903 places a radial load on the rotor 901. This load forces the outer band 906 to displace in a direction away from the radial surface 905, compressing an adjacent region of the compliant member 907. As such, the geometric center of the outer band 906 moves with respect to its unloaded position, such that it is no longer concentric with the pliable member 907.

The outer band 906 is a compliant material, such as stainless steel, that can withstand the environment (e.g., temperatures and pressures) of an internal combustion engine, and yet conform where in contact with the radial surface 905 of the cavity. In some embodiments, for example, the outer band may be stainless steel with a thickness of 0.025 inches to 0.075 inches.

To these ends, the rolling rotor 901 may include several concentric layers. For example, a compliant member 907, such as a compliant tube in FIG. 9C may be disposed concentrically within the outer band 906, and in-between the outer band 906 and the eccentric shaft 902. In some embodiments, the compliant member 907 may be a pair of O-rings disposed within the outer band. Such O-rings may include Polyetherketone (PEK) or polyetheretherketone (PEEK) materials. In other embodiments, the compliant member 907 may include a plurality of metal “leaves.”

Some embodiments include a bearing, such as a needle bearing 908, within the rolling rotor 901. Such a bearing may be a part of the rolling rotor 901, or may be part of the eccentric shaft 902.

In operation, the rolling rotor 901 will roll along the radial surface 905 of the cavity 903.

The deformed portion of the rolling rotor 901 provides a number of benefits. First, it acts as a seal between chambers on either side of point where the rotor contacts the radial surface 905 of the cavity 903 (e.g., a compression chamber and a combustion chamber, as described in other embodiments herein), without the need for an apex seal on the rotor 901. Second, the width of the deformed portion 909 (arc) of the rolling rotor 901 covers the interface between the recess 910 and the remainder of the cavity 903. This effectively creates a combustion chamber that will maintain a constant volume (specifically, the volume of the recess) for as long as the deformed portion 909 covers that interface.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. An internal combustion engine for executing an engine cycle, the engine comprising:
a housing having an intake port and an exhaust port;
a rotor rotationally mounted to move in a cavity within the housing;
a compression gate movable with respect to the housing and the rotor;
an expansion gate movable with respect to the housing and the rotor;
a gate drive arrangement, including at least one gate crankshaft, that drives the compression and expansion gates synchronously with the rotor; and
a third gate movable with respect to the housing and the rotor and configured to engage the rotor;
wherein the rotor, compression gate and expansion gate move synchronously during a period of the engine cycle, such that (i) during an intake phase of the engine cycle, the housing, rotor and third gate form an intake chamber, the intake chamber exposed to the intake port; (ii) during a compression phase of the engine cycle, the housing, rotor and compression gate form a compression chamber of finite volume, the rotation of the rotor reducing the volume of the compression chamber from a first volume to a second volume, the second volume being less than the first volume, so as to compress a working medium within the compression chamber; (iii) during a heat addition phase of the engine cycle the volume of the working medium is held substantially constant at the second volume; (iv) during an expansion portion of the cycle, the housing, rotor and expansion gate form an expansion chamber, the rotation of the rotor enlarging the volume of the expansion chamber from the second volume to a third volume, the third volume being greater than the first volume, and (v) during an exhaust portion of the engine cycle, the housing, rotor, the third gate, and the expansion gate form an exhaust chamber, the exhaust chamber exposed to the exhaust port.

2. A rotary engine according to claim 1, wherein at least one of the compression gate and the expansion gate is slidably mounted with respect to the housing.

3. A rotary engine according to claim 1, wherein at least one of the compression gate and the expansion gate is pivotally mounted with respect to the housing.

4. A rotary engine according to claim 1, further comprising a compression crank connecting arm coupling the compression gate to the compression crank.

5. A rotary engine according to claim 1, further comprising an expansion crank connecting arm coupling the expansion gate to the expansion crank.

6. A rotary engine according to claim 1, wherein the rotor is a right circular cylinder.

7. A rotary engine according to claim 1, wherein the rotor has a center of gravity at its axis of rotation.

8. A rotary engine according to claim 1, wherein during a heat addition phase of the engine cycle the volume of the working medium is held substantially constant at the second volume as the rotor turns at least five (5) degrees around its axis of rotation.

9. A rotary engine according to claim 1, wherein at least one of the compression gate and the expansion gate has a circular cross section.

10. A rotary engine according to claim 1, wherein the rotor is eccentrically mounted within the cavity to move rotationally.

11. A rotary engine according to claim 1, wherein the gate drive arrangement includes a compression gate crankshaft and an expansion gate crankshaft, wherein the compression gate crankshaft and the expansion gate crankshaft are coupled to the rotor.

12. A rotor for use in the working cavity of a rotary engine housing, the rotor comprising:
a cylindrical rotor body having a first face, and a working surface, the working surface having a radially indented notch at a juncture with the first face, the notch establishing a shoulder on the rotor body, the notch including a set of rotor teeth;
a floating seal ring movably disposed in the notch, the floating seal comprising sealing teeth complementary to and configured to intermesh with the rotor teeth, and the ring configured to move axially with respect to the rotor body;
wherein the floating seal engages the housing as the rotor moves within the working cavity, thus providing a sealing surface between the rotor and the housing.

13. A rotor according to claim 12, further comprising a compliant ring disposed between the floating seal and the notch, the compliant ring configured to urge the floating seal axially away from the rotor body, so as to engage the housing.

14. A rotor according to claim 13, wherein the compliant ring comprises a polymer.

15. A rotor according to claim 13, wherein the compliant ring comprises a spring.

16. A rotor according to claim 12, wherein the rotor teeth are disposed on the shoulder and protrude axially.

17. A rotor according to claim 12, wherein the rotor teeth are disposed on the shoulder and protrude radially.

18. A rotor according to claim 12, wherein the floating seal ring has a radial surface parallel to the working surface.

19. An internal combustion engine for executing an engine cycle, the engine comprising:
a housing having an intake port and an exhaust port, and a working chamber comprising an internal circumferential surface;
an eccentric shaft rotatably disposed within the working chamber;
a rotor rotatably coupled to the eccentric shaft, a radial surface of the rotor engaging the circumferential surface such that rotating the eccentric shaft causes the rotor to roll along the circumferential surface within the housing, wherein the radial surface of the rotor conforms to a contour of the circumferential surface as the rotor rolls.

20. An internal combustion engine according to claim 19, wherein the radial surface of the rotor comprises an outer band.

21. An internal combustion engine according to claim 20, wherein the outer band comprises stainless steel.

22. An internal combustion engine according to claim 21, wherein the stainless steel has a thickness of between 0.025 inches and 0.075 inches.

23. An internal combustion engine according to claim 19, further comprising a compliant tube within the outer band.

24. An internal combustion engine according to claim 23, wherein the compliant tube and the outer band are configured concentrically.

25. An internal combustion engine according to claim 23, further comprising a bearing within, and configured concentrically with, the outer band.
